(19) United States
(12) Patent Application Publication
(10) Pub. No.: US 2013/0138739 A1
(43) Pub. Date: May 30, 2013

(54) SYSTEM AND METHOD FOR SHARING DATA BETWEEN USERS IN A COLLABORATIVE ENVIRONMENT

(71) Applicant: NetOrbis Social Media Private Limited, Delhi (IN)

(72) Inventor: Rahul Uppal, Delhi (IN)

(73) Assignee: NetOrbis Social Media Private Limited, Delhi (IN)

(21) Appl. No.: 13/683,542

(22) Filed: Nov. 21, 2012

(30) Foreign Application Priority Data
Nov. 24, 2011 (IN) 3371/DEL/2011

(51) Int. Cl. G06F 15/16

(52) U.S. Cl. 709/204

(57) ABSTRACT

Disclosed is a method and system for sharing data between selective users in a collaborative environment. In one example, the method includes receiving a visibility selection from a user for one or more connections of the user. The one or more connections are selectively displayed as a connection of the user, to one or more target users viewing a connection list of the user.

### CROSS-REFERENCE TO RELATED APPLICATIONS

This application claims priority to India Patent Application No. 3371/DEL/2011, filed on Nov. 24, 2011, the entirety of which is hereby incorporated by reference.

### FIELD OF THE INVENTION

The present invention relates to sharing data in a collaborative environment.

### BACKGROUND

Internet may be a big contributing factor to globalization allowing connections among individuals and organizations residing in remote locations. Social media has further facilitated these connections by providing unique tools and platforms to facilitate connections among individuals and organizations having similar interest.

There are various social media platforms, which individuals and organizations connect and collaborate with one another. For instance, an intranet or an internal social media platform may be used to connect with employees internally, an external website, which may be primarily static in nature, may be used to communicate about the organization's various offerings, an extranet may also be used to connect with business partners, vendors and customers; and some organizations may also have external profiles on third party social media websites. Some of the above described platforms may be used primarily for one-way connection i.e. the organizations communicate about their services, policies, news etc., though there may be forms or applications to solicit feedback on these platforms.

The existing platforms may not allow organizations to have a two-way connection, for the purposes of sharing information and collaboration, in a social media environment with other organizations and individuals. Further, the existing platforms may not allow segregating information flow and assigning collaboration rights based on an organization's relationship with its various business partners, vendors and customers.

### SUMMARY OF THE INVENTION

A system and a method for sharing data between users in a collaborative environment are provided herein. In one example, the system includes a visibility module configured to receive and store visibility selection from a user for one or more connections of the user on the system and a selective data module configured to selectively display the one or more connections of the user, to one or more target users based upon the visibility selection received from the user.

In another example, the method includes receiving a visibility selection from a user for one or more connections of the user according to which the one or more connections may be selectively displayed as a connection of the user, to one or more target users viewing a connection list of the user.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 illustrates a block diagram of a client-server architecture.

FIG. 2 illustrates a block diagram of the client-server architecture including functional components.

FIG. 3 illustrates an exemplary collaborative environment for sharing data between selective users.

FIG. 4 illustrates a block diagram of a system to share data between selective users in a collaborative environment.

FIG. 5 illustrates a flowchart for sharing data between selective users in a collaborative environment.

FIG. 6 illustrates an exemplary flow chart for accessing a profile page of user B by user A.

FIG. 7 illustrates an exemplary user interface for posting updates in a USW.

FIG. 8 illustrates an exemplary user interface for sharing document in a USW.

FIG. 9 illustrates an exemplary user interface for managing connections in the USW.

### DETAILED DESCRIPTION OF THE DRAWINGS

The example systems and methods are described herein in detail for illustrative purposes and are subject to many variations.

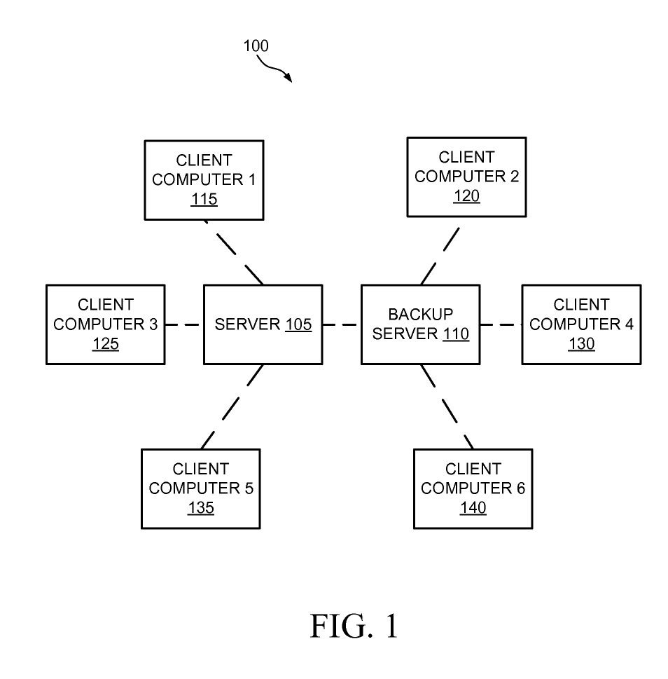

FIG. 1 illustrates a block diagram of a client-server architecture 100. The client-server architecture 100 includes a plurality of servers such as server 105 and backup server 110 and a plurality of client computers such as client computer 1 115, client computer 2 120, client computer 3 125, client computer 4 130, client computer 5 135 and client computer 6 140. The plurality of client computers may include but not be restricted to desktop computers or handheld mobile devices configured to access web pages such as a social network.

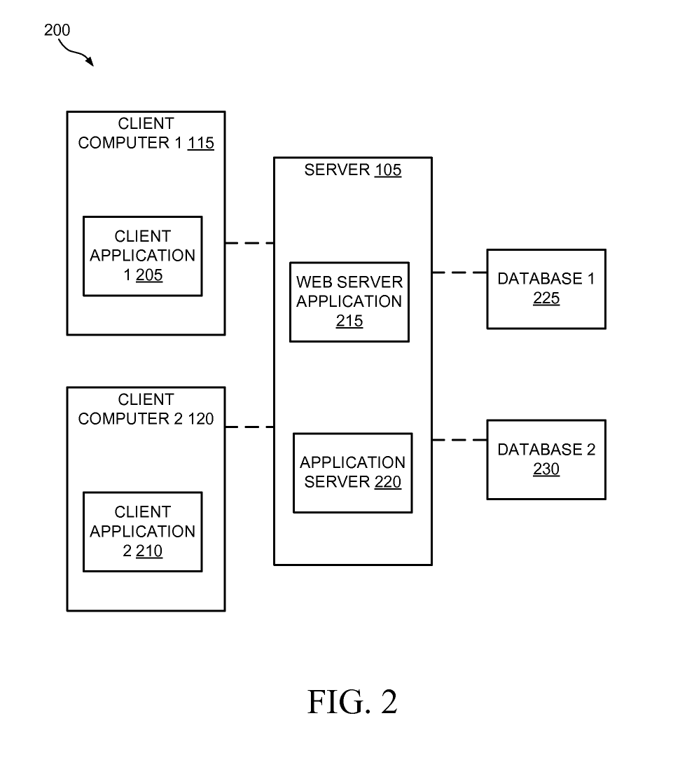

FIG. 2 illustrates a block diagram of the client-server architecture 200 including functional components. The client-server architecture 200 includes client computer 115 and client computer 120 of FIG. 1. The client computer 115 and the client computer 120 further includes client application 205 and client application 210 respectively. The client application 205 and client application 210 may use a web browser know in the art and facilitate a user to create a user profile in a social network.

The client application 205 and client application 210 may reside in an on-board storage of the client-computer 115 and client computer 120 or may be stored on the server 105 connected to the client computer 115 and client computer 120 from where it can be downloaded using the web browser on demand. The client application 205 and client application 210 are further configured to access a server-side software which may reside on the server 105. The server 105 further includes a web server application 215 and an application server 220. The web server application 215 is capable of performing conventional web server functions. The server 105 has accesses to one or more databases such as database 1 225 and database 2 230 which communicate with the web server application 215 and the application server 220 and provide storage facility for these applications.

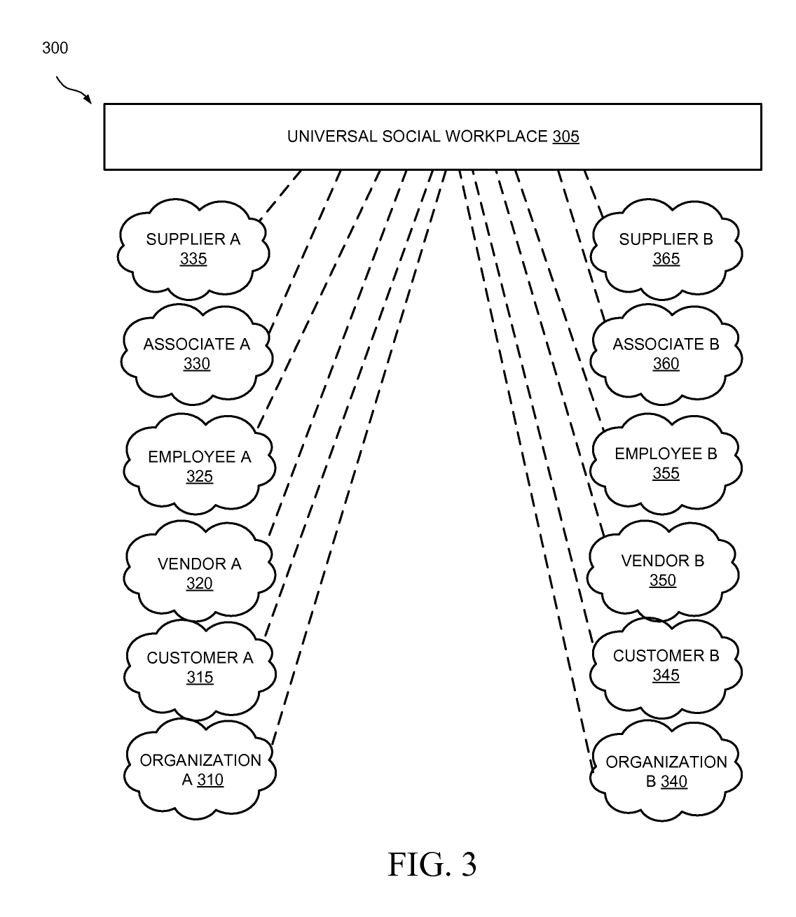

FIG. 3 illustrates an exemplary collaborative environment 300 for sharing data between selective users. The collaborative environment 300 may be implemented using client-server architecture 100 of FIG. 1 and can further be configured to run additional application platforms for conducting business and personal requirements.

In one example, the collaborative environment 300 includes a social networking system such as a universal social workplace (USW) 305. In one example, the USW 305 includes registered users such as organization A 310, customer A 315, vendor A 320, employee A 325, associate A 330, supplier A 335, organization B 340, customer B 345, vendor B 350, employee B 355, associate B 360 and supplier B 365 who are connected through the USW 305 through which they may share, store and receive data from one another.

Typically, to become the registered user of the social networking system, an individual user or an entity, registers for an account with the social networking system. Thereafter, the registered user may log into the social networking system via the account by providing a login ID or username and password. As used herein, the “registered user” may be an individual user, an entity such as an enterprise, business, or third party application, or a group of individuals or entities who interact or communicate over such a social networking system.

Further, when the registered user registers for the account with the social networking system, the social networking system may create and store a record, often referred to as a “user profile”, in association with the user. The registered user may identify other users of the social networking system that the registered user considers to be his connections. Connections in social networking system may be in both directions or may be in just one direction. In some examples, the social networking system allows the connection to be indirect via one or more levels of connections. Connections may be added explicitly by a user input, or may be suggested by the social networking system based on common characteristics of the users (e.g., users who belong to a same organization, users who belong to a same university or school, users who have listed similar interests in the user profile and so on).

There may be instances where the registered user may not want to share his connections with other users on the network, for example a ABC Corporation having connected with XYZ Inc a vendor and 123 Agencies another vendor, may not want XYZ Inc to know of its connection with 123 Agencies and vice-a-versa due to reasons of professional secrecy. Similarly, ABC Corporation may not want, both XYZ Inc and 123 Agencies to know of or have information on its various customers who may be connected with ABC Corporation through the USW 305. The registered user may want to restrict the connections that are visible to others by associating visibility settings with its one or more connections.

In one example, the user creates one or more connection groups by adding one or more connections of the user to the connection group. For example, the registered user may have several user types, who are connections with the user on the USW 305, which may include his/her friends, relatives, professional connections such as employees, associates, vendors, contractors, external partners, customers, etc. The registered user may create connection groups for each of the user type. For instance, the user may create a “friends” connection group and include connections who are friends into this connection group. Similarly, he may create a “relatives” connection group, an “employee” connection group, an “external partners” connection group a “customers” connection groups and so on and add connection to these various connection groups based on his preference.

Furthermore, upon creating connections on USW 305, visibility selection is received from the user in respect of the connections. Receiving visibility selection includes receiving visibility settings from the user for the one or more connections, according to which the created one or more connections are selectively displayed as connections of the user to one or more target users trying to access a connection list of the user. The term ‘target user’ referred to herein includes any users on the USW 305 system trying to access or view the user profile or connection list of another user on the USW 305. The connection list is the list where connections of a user are displayed on the USW 305. Alternatively, the visibility selection may be received in respect of a group of connection referred to as a connection group according to which the one or more connections present in the connection group are selective displayed as connections of the user on the USW.

Consider an exemplary scenario where organization A 310 is the registered user of USW and wants to collaborate on a project using the USW 305. The project may use USW to communicate with several connections and/or connection groups on the USW 305 who may inter alia be his employee A 325, associate A 330, vendor A 320, supplier A 335, customer A 315 etc. organization A 310 in this case may create several connection groups for the aforementioned types of connections and add these connections to their respective groups. A visibility selection may be set by organization A 310 for every connection and/or connection groups so that the connections are selectively displayed in the connection list of the organization A 310 to other users. For instance, the organization A 310 may set visibility of connection group vendor A 320 to be visible only the connection group employee A 325 of the organization A 310. Similarly, organization A 310 may set visibility of its customer A 315 connection group to both employee A 325 connection group as well associate A 330 connection group for engaging with customer A 315 to obtain feedbacks and reviews in respect of organization A 310's products and reviews.

In yet another example, visibility selection may be further received for connections in a connection group such that they are not visible to other connections from the same connection group. For instance, organization A 310 may want to collaborate with several vendors on a project using USW 305, but it may not want every vendor to know which other vendors are also connected with the organization A 310 and communicating with organization A 310 on the same project. In this case, organization A 310, may further choose to set visibility setting for every connection in the vendor A 320 connection group to ‘self’, so that the connection to the vendor is visible only to organization A 310 and the vendor does not appear as a connection of organization A 310 to other users on the USW 305.

In a further example, the user may choose to selectively share data and information at one go with various connections and connection groups while maintaining selective visibility of its connections on the USW 305. For instance, organization A 310 may want to collaborate with various stake holders such vendor A 320, supplier A 335, customer A 315 and its employee A 325 on a new product launch and in the process may desire to selectively disseminate information to various stake holders e.g. general product information may be shared with connection group vendor A 320, employee A 325 and customer A 315, whereas product development information may be shared only with connection group employee A 325. Similarly, information regarding product specification or raw material list may be shared only with connection group vendor A 320, supplier A 335 and employee A 325. Organization A 310 may further set the visibility setting of every connection in the vendor A 320 connection group to self in which case, vendors may not know which other vendors are also connections of organization A 310 and may be participating in the project.

The system may be further configured to provide a two way communication system wherein the connection and/or groups collaborating on a project may also be allowed to selective share information and updates in return. For instance, in response to a product specification update selectively shared by organization A 310 with connection group vendor A 320 and employee A 325, each vendor may reply with product supply details to organization A 310. Visibility may be set by organization A 310 for such replies such that they are also selectively shared with one or more connection or connection groups on the USW system 305.

Consider another exemplary scenario in which the organization A 310 collaborate on a product development project only with selected employees, vendors and suppliers at specific geographical locations. In this case, the organization A 310 can create connection groups including preferred connections residing at a geographical location for example, South East Asia. The organization A 310 can then selectively share the data related to the product development with the created preferred connection group while maintaining appropriate visibility settings between the various connections in the connection groups. Furthermore, the organization A 310 may also define a time during which the shared data is accessible to such connection.

In yet another example, the USW 305 includes various user interfaces for sharing updates, sharing documents and defining access rights and so on. The user interfaces for sharing updates, sharing documents and defining access rights are described in further examples.

In yet another example, the USW 305 may be configured to provide folder/file storage and selective sharing functionality and other productivity tools to make collaboration on USW more efficient. Taking example of the online collaboration for product development describe above herein, the organization A 310 may further choose to share documents and files on USW 305 in the same manner as information sharing is described hereinabove. Restrictions may be configured for accessing these documents such password protection, encryption or any other security method known in the art.

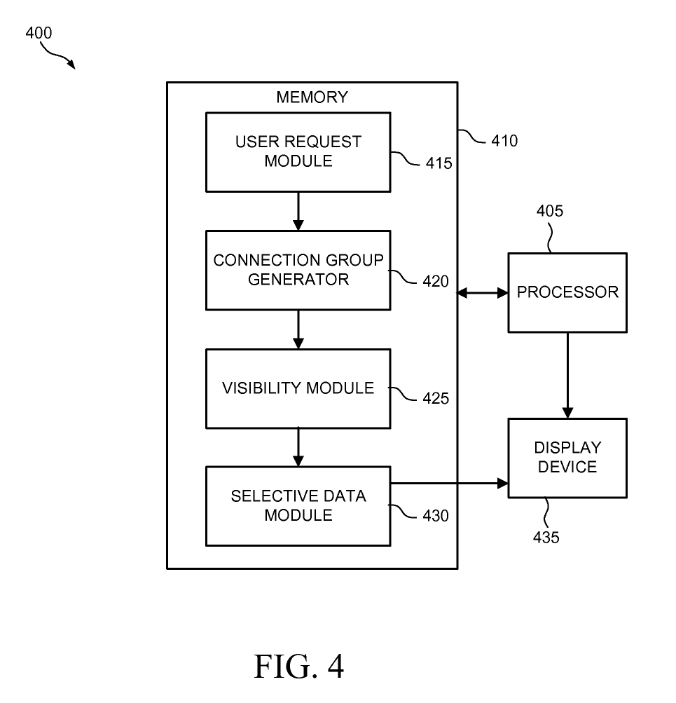

FIG. 4 illustrates a block diagram of a system 400 to share data between selective users in a collaborative environment. The system 400 includes a processor 405, a memory 410 and a display device 435. The memory further includes a user request module 415, a connection group generator 420 a visibility module 425 and a selective data module 430. In one example, the collaborative environment may be a social network such as the USW 305. The system 400 may be present in a client-server architecture described in FIG. 2.

A user may connect and form connections with one or more users on USW. Upon forming the one or more connections, the visibility module 425 is configured to receive visibility selection from the user for the one or more connections. The visibility selection is then stored in the visibility module 425. The selective data module 430 operatively connected to the visibility module 425 is configured to selectively display the one or more users as connections of the user to one or more target users on the system based upon the visibility selection received from the user.

Consider an example, where one or more target users request to access the connection list of the user. The request is processed by the selective data module 430 upon receipt of the same from the target user. The selective data module 430 identifies if the one or more target users are connections of the user. If the one or more target users are identified as connections, then the connections of the user set to visible to the one or more target users are displayed. If the one or more target users are not identified as connections to the user, then connections set to ‘visible to public’ are displayed to the one or more target users.

In one example, upon receiving the visibility selection from the user, in respect of any other user who is a connection to the first user, corresponding visibility rights are created by the visibility module 425 in respect of connections or connection groups who are designated to view the other user as a connection to the first user. The visibility rights are also stored in the visibility selection module 425. For instance, if visibility selection is received for a connection group customer to be visible to connection group vendors and associates, corresponding visibility rights are created in respect of connection groups vendors and associates enabling them to view the connections in the connection group customer of the user.

In another example, the selective data module 430 is further configured to display user profile data in addition to connections of the user based upon the visibility selection received from the user in relation to the user profile data. The user profile data may include but not be restricted to informational updates or documents shared by the user on the USW.

In another example, one or more connection groups are generated by the connection group generator 420 upon a user request received in this regard on USW 305. In one example, the user request is received at the user request module 415, which is operatively connected to connection group generator 420. The connection groups are generated by adding one or more connections of the user to a group either by a user input or using pre-defined criteria. The user input may desire the user to assign every connection in his list to a connection group created by the user. Alternatively the pre-defined criteria, such as common characteristics of between the connections (e.g., users who belong to a same organization, users list same university or school under educational information in the user profile or users who have listed similar interests in the user profile and so on), may be identified by the system and used to group user's connection or suggest connection groups to the user. For instance, a user may have several connections some of which may be his/her friends relatives or professional connections such as colleagues, customers, employees, partners, etc. The user may group each of these connection types into connection groups; for example, the user may add friends to the connection groups friends or relatives to the connection groups relatives and colleagues to connection groups colleagues and so on. Alternatively, the system may identify common characteristics among the various connections of a user to automatically form or suggest connection groups to the user such as in the case where the user forms connection with a colleague on USW, the colleague is automatically added to the connection group colleagues by the system upon identifying the connection having listed the same organization in the professional section of his profile.

Upon generating the one or more connection groups, the visibility module 425 operatively connected to the connection group generator 420, receives a visibility selection for the generated one or more connection groups from the user which selection is stored in the visibility module 425 and determines the visibility of the connection group and the connections contained therein to other user, connections of the user in the USW 305.

In yet another example, upon generating the one or more connection groups, the visibility module 425 is further configured to categorize the generated connections groups as visible to public, visible only to certain connection groups and not visible to anyone. In one example, the received visibility selection is stored in the visibility module 425.

Further upon receiving the visibility selection from the user, the selective data module 430 which is operatively connected to the visibility module 425 and the display device 435 selectively displays users in connection groups as connections to one or more target users trying to access connection list of the user. The display device 435 may be a display such as that of a computer or a handheld mobile device of the one or more target users.

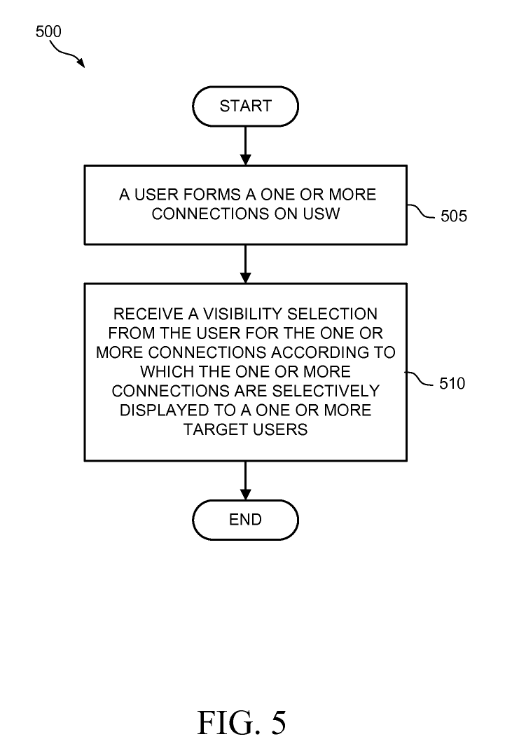

FIG. 5 illustrates a flowchart 500 for sharing data between selective users in a collaborative environment. At process block 505, one or more connections are formed by a user on a USW. At process block 510, a visibility selection is received from the user for the one or more connections of the user according to which the one or more connections are selectively displayed as a connection of the user, to one or more target users viewing a connection list of the user.

Consider an example where a request is received from one or more target user to access a connection list of the user. Upon receiving the request, the request is processed to identify if the one or more target users are connections to the user. If the one or more target users are identified as connections, then connections of the user set as visible to the one or more target users are displayed to the one or more target users. If the one or more target users are not identified as connections to the user, then connections set to ‘visible to public’ are displayed to the one or more target users.

In an example, the one or more connections are grouped into one or more connection groups. The one or more connection groups are created by the user upon selecting an adding one or more connections to a group or accepting groups created by the USW system using any of the pre-defined criteria.

Further, a visibility selection is received from the user for the created one or more connection groups. Based upon the received visibility selection, the connections present in the connections groups are selectively displayed as connections of the user, to one or more target users viewing a connection list of the user.

In one example, upon receiving the visibility selection from the user in respect of any other user who is a connection to the first user, corresponding visibility rights are created in respect of connections or connection groups who are designated to view the other user as a connection to the first user. For instance, if visibility selection is received for a connection group customer to be visible to connection groups vendors and associates, corresponding visibility rights are created in respect of connection groups vendors and associates enabling them to view the connections in the connection group customer of the user.

In another example, when connections are not assigned to any group by the user, they may be automatically added to a default connection group such as ‘others’ by the connection group generator. The default group may be further assigned a default visibility selection to ‘self’ to ensure that these connections are not visible as connections to other user on the USW 305 until the user removes the default visibility settings or assigns the connection to a new group.

In yet another example, receiving the visibility selection for the created one or more connection groups includes categorizing the created connection groups as visible to public, visible only to certain connection groups and not visible to anyone.

In yet another example, a request is received from one or more target users to access a user profile data of the user in the USW. For instance, the user profile data may include connection list, shared update and shared folder. Upon receiving the request from the one or more target users, visibility rights created in respect of the one or more target users are retrieved and the user profile data is selectively displayed to the one or more target users based on the retrieved visibility rights.

In yet another example, the user may share updates on the USW comprising information and articles of interest. The user may additional assign a visibility selection to the shared update to be visible to one or more connections of the user. The shared update may then selectively be displayed tone or more connections of the user having a visibility right to view the shared update.

In yet another example, a request is received from one or more target users to access a document folder of the user on USW which may be further assigned a visibility selection. Upon receiving the request, the visibility right for the one or more target user are retrieved from a database and the folder is selectively displayed to the one or more target users based on the retrieved visibility right of the target user. In yet another example, user may assign a separate visibility selection to sub-folders. For instance, if the user has chosen a folder to be visible to public, then sub-folders and files within that folder could be visible to public by default. However, the user may assign a different visibility selection for any of the sub-folders and files. In yet another example, access rights may be defined by the user for folders that are shared. The access rights may include but not be restricted to “view” and “edit”. The access rights enable one or more target users to “view” and/or “edit” the folder.

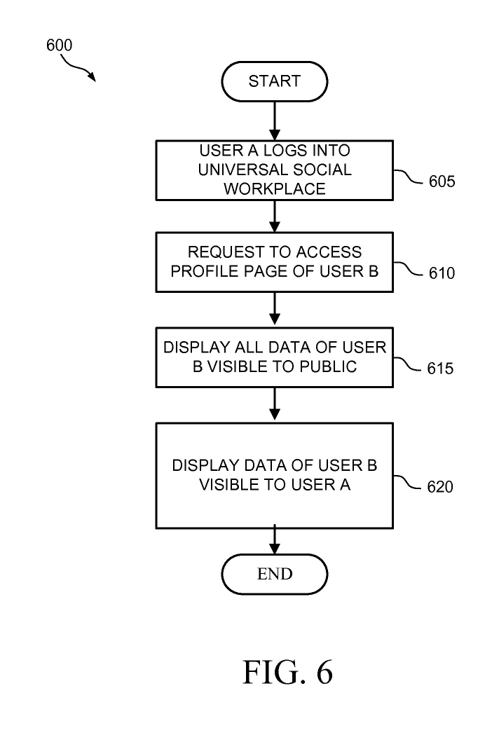

FIG. 6 illustrates an exemplary flow chart 600 where user A is accessing profile page of user B. At process block 605, user A logs into a universal social workplace. The user A logs into the USW using a user ID and a password. At process block 610, user A requests to access profile page/connection list of user B.

Upon receiving the request, the connection group of user A is identified. In one example, if the user is not listed in any of the connection groups of user B then information designated public by user A is made available to the user. At process block 615, data of user B that are visible to public is displayed as users have access to data posted as public. At process block 620, data of user B that is made visible by user B to user A through visibility selection, in addition to public data is displayed according to the identified visibility right of the connection group that A belongs to and the process is ended. If the user is individual connection, then data visible to public is displayed. In one example, if the user B is viewing his/her own profile, then data that are not visible only to self is also displayed. The data may include the updates and information shared by user A as well as information on the various users of USW 305 listed as connections to user A in user A's connection list.

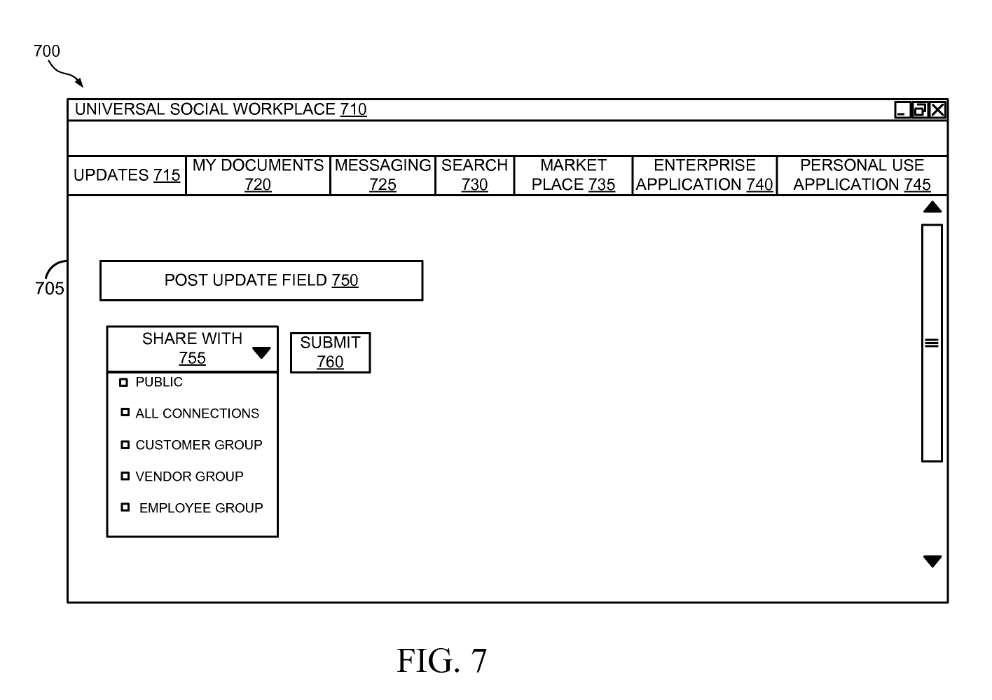

FIG. 7 illustrates an exemplary user interface 705 for posting updates in a USW 710. 700 of FIG. 7 includes the USW 710 which further includes tabs/links such as updates 715, my documents 720, messaging 725, search 730, market place 735, enterprise application 740 and personal use application 745. In this example, a user such as an organization/ individual has selected the updates 715 tab. The updates 715 tab further includes a post update field 750 where the user posts updates regarding any information and shares the information with one or more connection groups by providing visibility selection. For instance, the organization may post updates relating to recently launched products, a customer may post a query regarding a product. Upon posting the update in the post update field 750, the user is presented with a drop down menu “share with” 755, where the user is presented with a list of connection/connection groups created by the user. The user may select the connections/connection groups with which he/she may want share the update using the drop down menu. If the user does not wish to share the update with any of the existing connections/connection groups created by the user, then the user may create a new connection group/ new connection with whom the update is to be shared. After making the selection, the user submits the update using submit button 760. Upon submitting, the update is displayed selectively to the connection in the selected one or more connection groups or made available to the public.

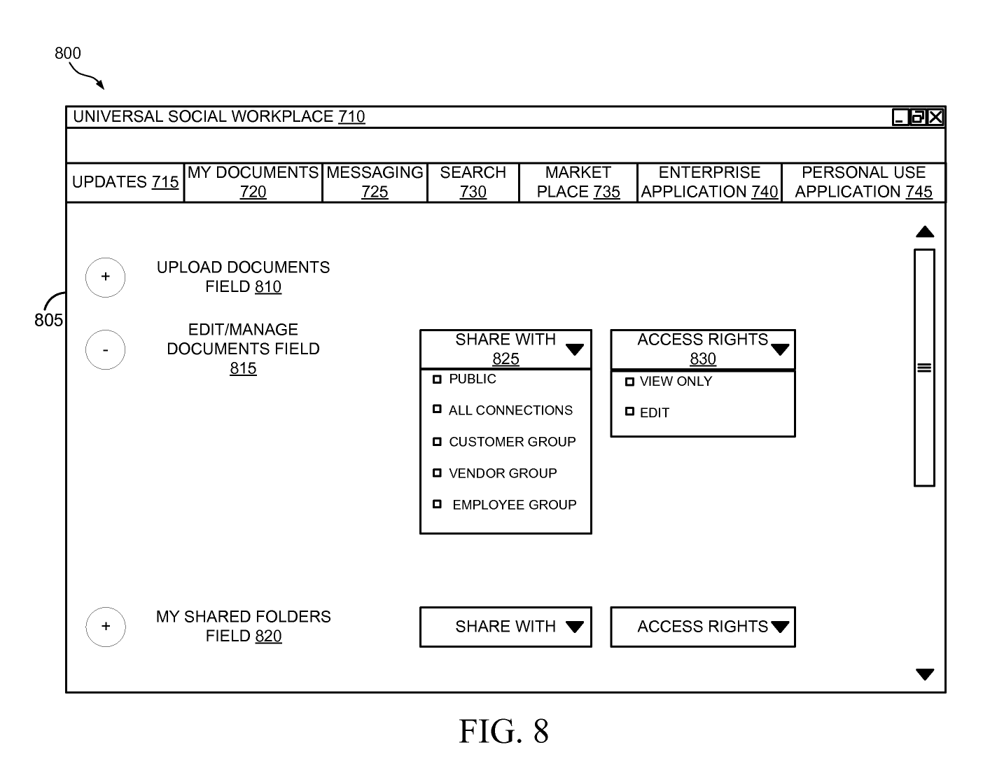

FIG. 8 illustrates an exemplary user interface 805 for sharing document in the USW 710. 800 of FIG. 8 include the USW 710 where a user such as an organization/individual has selected my document 720 tab. The user interface 805 of my document 720 tab further includes upload document field 810, edit/manage documents field 815 and my shared folder field 820. In the example, the user has selected edit/manage documents field 815. Upon selection, the user is presented with a share with 825 drop down menu, where the user can select one or more connection/connection groups with whom he/has wants to share the document. Upon selection of the one or more connection groups, the user is presented with access rights 830 drop down menu where the user can define access rights “view” or “edit” or share to the selected connection/connection group to display the document selectively.

In one example, the user can select upload document field 810 to upload a document. Upon uploading the document, the user is presented with a share with drop down menu in which the user can select with whom the document has to be shared and then the user is presented with access right drop down menu to define access right.

In another example, the user can select my shared folders field 820 which includes the shared folders information. For instance, UI associated with the shared Folders can include the files shared with the user in alphabetic order of author's names or in a chronological sequence. Alternatively, there could be sub-folders created for every other user that has shared a document/folder with the user. Within those sub-folders, documents could be arranged chronologically or alphabetically.

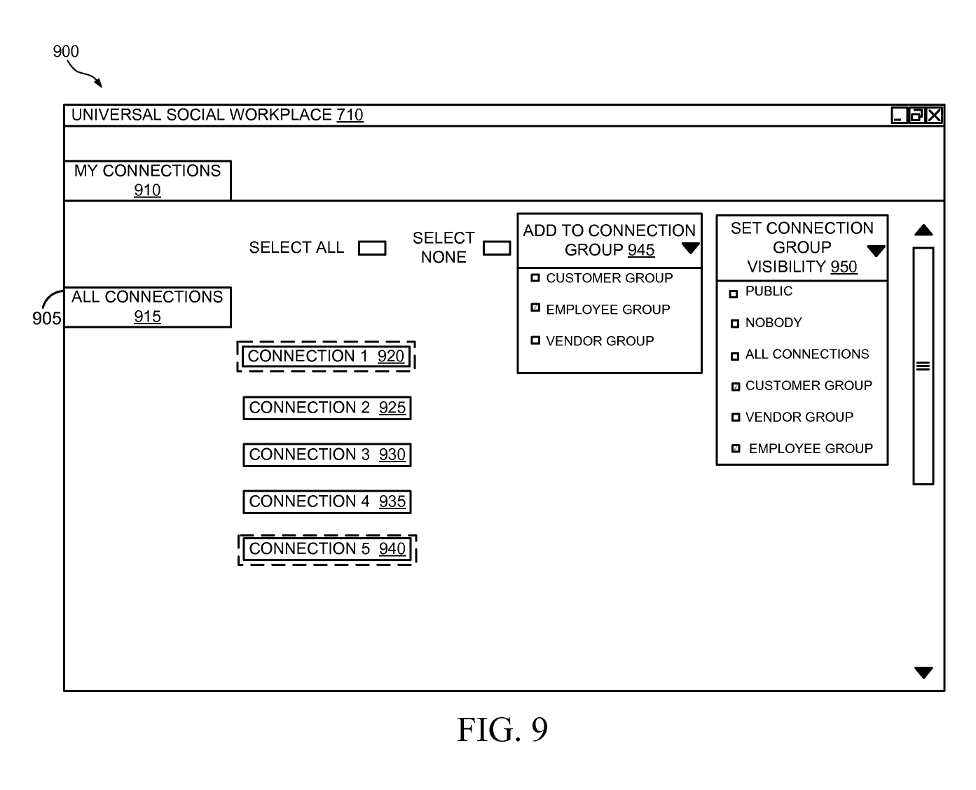

FIG. 9 illustrates an exemplary user interface 905 for managing connections in the USW 710. 900 of FIG. 9 include the USW 710 where a user such as an organization/individual has selected my connection tab 905. User interface 910 includes various connections of the user such as a connection 1 920, connection 2 925, connection 3 930, connection 4 935 and connection 5 940. In this example, the user is managing his/her connections for creating a connection group. In this example, the user selects connection 1 920 and connection 5 940 and wants to add them to employee group in add to connection group 945 drop down menu. Upon selecting the employee group in add to connection group 945, the user is presented with set connection group visibility 950, where the user selects employee group and customer group to enable connections of the employee group and the customer group to view the connection employee group of the user. In another example, there could be pre-defined rules defined by a system or the user) used to segregate connections in connection groups. For instance, users with the same employer name may be automatically included in a colleagues connection group.

Exemplary aspects, features, and components of the system are described above. However, the system may be implemented in many different ways. For example, although some features are shown stored in computer-readable memories (e.g., as logic implemented as computer-executable instructions or as data structures in memory), all or part of the system and its logic and data structures may be stored on, distributed across, or read from other machine-readable media. The media may include hard disks, floppy disks, CD-ROMs, a signal, such as a signal received from a network or received over multiple packets communicated across the network.

The system may be implemented with additional, different, or fewer components. As one example, a processor may be implemented as a microprocessor, a microcontroller, a DSP, an application specific integrated circuit (ASIC), discrete logic, or a combination of other types of circuits or logic. As another example, memories may be DRAM, SRAM, Flash or any other type of memory. The processing capability of the system may be distributed among multiple components, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (e.g., a dynamic link library (DLL)). The DLL, for example, may store code that prepares intermediate mappings or implements a search on the mappings. As another example, the DLL may itself provide all or some of the functionality of the system, tool, or both.

The foregoing descriptions of examples of the methods and systems have been presented for purposes of illustration and description. They are not intended to be exhaustive or to limit the present disclosure to the precise forms disclosed, and obviously many modifications and variations are possible in light of the above teaching. The examples were chosen and described in order to best explain the principles of the present disclosure and its practical application, to thereby enable others skilled in the art to best utilize the present disclosure and various examples with various modifications as are suited to the use contemplated. It is understood that various omission and substitutions of equivalents are contemplated as circumstance may suggest or render expedient, but such are intended to cover the application or implementation without departing from the spirit or scope of the claims of the present disclosure.

1. A system to share data between users in a collaborative environment, the system comprising:
a processor;
a memory in communication with the processor for storing:
a visibility module configured to receive and store visibility selection from a user for one or more connections of the user; and
a selective data module configured to selectively display the one or more connections of the user, to one or more target users based upon the visibility selection received from the user.

2. The system of claim 1, wherein the memory further comprises a connection group generator configured to generate one or more connection groups from the one or more connections of the user.

3. The system of claim 2, wherein the one or more connection groups are generated based on a user input.

4. The system of claim 2, wherein the one or more connection groups are generated based on a pre-defined criteria comprising of common characteristic identified between the one or more connections and the user.

5. The system of claim 2, wherein the visibility selection is received in respect of the one or more connection groups.

6. The system of claim 1, wherein a selective data module further displays user profile data in addition to connections of the user based upon the visibility selection received from the user in relation to the user profile data.

7. The system of claim 6, wherein the user profile data comprises updates shared by the user.

8. The system of claim 6, wherein the user profile data comprises one or more documents shared by the user.

9. The system of claim 1, wherein the selective data module is operatively linked to a display device.

10. A method for sharing data between selective users in a collaborative environment, the method comprising:
receiving a visibility selection from a user for one or more connections of the user according to which the one or more connections are selectively displayed as a connection of the user, to one or more target users.

11. The method of claim 10, wherein the connections are grouped into one or more connection groups.

12. The method of claim 10 or 11, wherein visibility selection is received in respect of the one or more connection groups.

13. The method of claim 10 further comprises:
receiving a user request from the one or more target users for accessing user profile data of the user;
retrieving the visibility rights created in respect of the one or more target users; and
selectively displaying the user profile data to the one or more target users based on the retrieved visibility rights.

14. The method of claim 13, wherein user profile data comprises a connection list.

15. An article of manufacture including a computer readable storage medium to tangibly store instructions, which when executed by a computer, cause the computer to:
receive a visibility selection from a user for one or more connections of the user according to which the one or more connections are selectively displayed as a connection of the user, to one or more target users.

16. The article of manufacture of claim 15, wherein the connections are grouped into one or more connection groups.

17. The article of manufacture of claim 15 wherein the computer is further operable to:
receive a user request from the one or more target users for accessing user profile data of the user;
retrieve the visibility rights created in respect of the one or more target users; and
display the user profile data selectively to the one or more target users based on the retrieved visibility rights.
